(19) United States
(12) Patent Application Publication
(10) Pub. No.: US 2022/0246349 A1
(43) Pub. Date: Aug. 4, 2022

(54) RESONANT LC STRUCTURE WITH STANDALONE CAPACITORS

(71) Applicant: Resonant Link LLC, Shelburne, VT (US)

(72) Inventors: Aaron Stein, Essex, VT (US); Phyo Aung Kyaw, Winooski, VT (US)

(21) Appl. No.: 17/547,864

(22) Filed: Dec. 10, 2021

Related U.S. Application Data
(63) Continuation of application No. PCT/US2021/015260, filed on Jan. 27, 2021.
(60) Provisional application No. 62/967,482, filed on Jan. 29, 2020.

(51) Int. Cl. H01F 27/40; H01F 27/28; H01F 27/24; H02J 50/12

(52) U.S. Cl. CPC H01F 27/40; H01F 27/2804; H01F 2027/2809; H02J 50/12; H01F 27/24

(57) ABSTRACT

A resonant coil includes a plurality of conductors forming a plurality of inductively coupled current loops. The plurality of conductors include a first conductor having a first end and a second end, the first end and the second end being separated by a first gap; and a second conductor having a third end and a fourth end, the third end and the fourth end being separated by a second gap. The resonant coil also includes at least one standalone capacitor comprising at least one first capacitor connected to the first end and the second end of the first conductor.

### RELATED APPLICATIONS

This application claims priority under 35 U.S.C. § 120 to and is a continuation of International Application No. PCT/US2021/015260, filed Jan. 27, 2021, which claims the benefit under 35 U.S.C. § 119(e) of the filing date of U.S. Provisional Application Ser. No. 62/967,482, filed Jan. 29, 2020, each of which is incorporated herein by reference.

### BACKGROUND

### 1. Technical Field

The apparatus and techniques described herein relate to LC structures with standalone capacitors.

### 2. Discussion of the Related Art

Electrical conductors capable of handling high-frequency (HF) alternating current (AC) without incurring high losses are useful for building high-performance magnetic components, which are used in inductors and transformers for power conversion, RF and microwave circuits, and which can generate an external magnetic field for use in wireless power transfer, induction heating and magnetic hyperthermia, among other applications. Electrical conductors operating at high frequency are impacted by the skin effect and the proximity effect, which leads to higher power losses. The former confines the HF current to the surface of the conductors, thereby significantly reducing the effective conductor cross-section; the latter causes magnetic field from one conductor to incur extra losses in adjacent conductors, resulting in non-uniform current density among conductors.

As a result of the skin effect and the proximity effect, the amount of effective conductor cross-sectional area which carries the electrical current is limited to less than twice the skin depth of the conductor at the frequency of operation. For frequencies up to around 1 MHz, litz wire, which includes multiple fine strands of individually insulated wires twisted together, can be used to overcome this limitation. However, for effective use of litz wire, the individual strands should be much thinner than the skin depth at the frequency of operation. Higher performance compared to litz wire has been demonstrated by multilayer conductors with integrated capacitors for resonant power conversion and wireless power transfer applications, as described in U.S. Pat. No. 10,109,413 and PCT application PCT/US2017/043377. Such structures are formed of many foil conductors with approximately equal current densities, including an integrated capacitance due to the dielectric layers separating the foil conductors from one another. These multilayer conductors with integrated capacitors provide high performance since foil conductors are available in much smaller thicknesses compared to litz wire strands.

### SUMMARY

Some aspects relate to a resonant coil, comprising: a plurality of conductors forming a plurality of inductively coupled current loops, the plurality of conductors comprising; a first conductor having a first end and a second end, the first end and the second end being separated by a first gap; and a second conductor having a third end and a fourth end, the third end and the fourth end being separated by a second gap; and at least one standalone capacitor comprising at least one first capacitor connected to the first end and the second end of the first conductor.

The first gap may be approximately aligned with the second gap.

The first conductor and the second conductor may be in respective layers of a printed circuit board.

The at least one standalone capacitor may provide a resonant capacitance for the resonant coil.

A capacitance between the first conductor and the second conductor substantially may not contribute to the resonant capacitance.

The at least one standalone capacitor may further comprise at least one second capacitor connected to the third end and the fourth end of the second conductor.

The first and second conductors may be galvanically isolated from one another.

The first and second conductors may be galvanically connected to one another.

The galvanic connection may be formed by making a break in the first and second conductors and connecting the respective ends of the break of the first and second conductors.

Some of the conductors may be galvanically isolated from one another, and some of the conductors may be galvanically connected to one another, wherein the galvanic connection is formed by making a break in the first and second conductors and connecting the respective ends of the break of the first and second conductors.

The first and second conductors may each have a C-shape.

The first and second conductors may be planar.

The first conductor and the second conductor may each have a toroidal C-shape with an open cross-section or a closed cross section.

The first conductor may be nested within the second conductor.

The at least one standalone capacitor may comprise a plurality of standalone capacitors with interleaved connections to at least the first and second conductors.

The resonant coil may further comprise a third conductor outside an edge of the first conductor, the first conductor having a smaller width than that of the first conductor.

The first and second conductors may have different thicknesses.

The first and second conductors may be approximately concentric.

Some aspects relate to a resonant coil comprising a plurality of galvanically isolated current loops with one or more standalone capacitors, wherein the galvanically isolated current loops are strongly inductively coupled to one another.

Some aspects relate to a resonant coil comprising a plurality of galvanically isolated current loops in a winding region connected to standalone capacitors, wherein the galvanically isolated current loops are inductively coupled to one another, wherein the magnetic coupling coefficient between adjacent galvanically isolated current loops exceeds k=0.1 and/or a space between adjacent galvanically isolated current loops is less than ⅓rd an average diameter of the galvanically isolated current loops.

The magnetic coupling coefficient between adjacent galvanically isolated current loops may exceeds k=0.8 and/or a space between adjacent galvanically isolated current loops may be less than 1/10th the average diameter.

The magnetic coupling between adjacent galvanically isolated current loops may exceed k=0.9 and/or space between adjacent galvanically isolated current loops may be less than 1/15th the average diameter.

Some aspects relate to a plurality of C-shaped current loops in the winding region with standalone capacitors where each current loop is separated by a dielectric layer so that each current loop is galvanically isolated, wherein the currents loops are approximately concentric and a gap in the C-section of each current loop is approximately in the same circumferential location.

Some aspects relate to a resonant coil comprising a plurality of washer shaped current loops in the winding region with one or more breaks where each break has at least one standalone capacitor, wherein each current loop is separated by a dielectric layer so that each layer is galvanically isolated, and wherein the current loops are approximately concentric and gaps in the washers are approximately in the same circumferential location.

Some aspects relate to a resonant coil comprising a plurality of nested toroidal shaped current loops in the winding region with one or more breaks where each break has at least one standalone capacitor, wherein each conductor is separated by a dielectric layer so that each layer is galvanically isolated, and wherein the current loops are approximately concentric and the gaps in the washers are approximately in the same circumferential location.

Some aspects relate to a resonant coil comprising a plurality of nested toroidal shaped current loops in a winding region with one or more breaks where each break has at least one standalone capacitor, wherein each current loop is separated by a dielectric layer so that each layer is galvanically isolated, wherein the current loops are approximately concentric and the gaps in the washers are approximately in the same circumferential location, wherein the current loops are inductively coupled, and wherein the magnetic coupling coefficient between adjacent current loops exceeds k=0.1 and/or a space between adjacent current loops is less than ⅓rd an average diameter of the current loops.

Some aspects relate to a resonant coil comprising a plurality of nested toroidal shaped current loops in a winding region with one or more breaks where each break has at least one standalone capacitor, wherein each current loop is separated by a dielectric layer so that each layer is galvanically isolated, wherein the current loops are approximately concentric and the gaps in the washers are approximately in the same circumferential location, wherein the current loops are inductively coupled, wherein the magnetic coupling coefficient between adjacent current loops exceeds k=0.8 and/or a space between adjacent current loops is less than 1/10th an average diameter of the current loops.

Some aspects relate to a resonant coil comprising a plurality of nested toroidal shaped current loops in a winding region with one or more breaks where each break has at least one standalone capacitor, wherein each current loop is separated by a dielectric layer so that each layer is galvanically isolated, wherein the current loops are approximately concentric and the gaps in the washers are approximately in the same circumferential location, wherein the current loops are inductively coupled, wherein the magnetic coupling coefficient between adjacent current loops exceeds k=0.9 and/or a space between adjacent current loops is less than 1/15th an average diameter of the current loops.

Some aspects relate to a resonant coil comprising a plurality of multiturn current loops in a winding region, where each current loop has at least one standalone capacitor, wherein the multiturn current loops are inductively coupled, wherein the magnetic coupling coefficient between adjacent current loops exceeds k=0.1 and/or a space between adjacent current loops is less than ⅓rd an average diameter of the current loops.

Some aspects relate to a resonant coil comprising a plurality of multiturn current loops in a winding region, where each current loop has at least one standalone capacitor, wherein the multiturn current loops are inductively coupled, wherein the magnetic coupling coefficient between adjacent current loops exceeds k=0.8 and/or a space between adjacent current loops is less than 1/10th an average diameter of the current loops.

Some aspects relate to a resonant coil comprising a plurality of multiturn current loops in a winding region, where each current loop has at least one standalone capacitor, wherein the multiturn current loops are inductively coupled, wherein the magnetic coupling coefficient between adjacent current loops exceeds k=0.9 and/or a space between adjacent current loops is less than 1/10th an average diameter of the current loops.

An apparatus may comprise the resonant coil and a high-permeability magnetic material to shape the magnetic field, and optionally the high-permeability magnetic material forms a pot core or toroid.

The conductor thicknesses may be varying and optionally decreasing in size in high-magnetic field regions.

The one or more standalone capacitors may be interleaved.

The plurality of standalone capacitors of may be of equal capacitance.

The standalone capacitors may have increasing capacitance for increasing thickness of the conductor to which the standalone capacitor is affixed.

The capacitance may increase approximately proportionally to the increasing thickness of the conductor.

The standalone capacitors may have a capacitance increased in size in high magnetic field regions.

Some aspects relate to a resonant coil comprising at least one planar multiturn spiral current loop.

Some aspects relate to a resonant coil comprising at least two planar multiturn spiral current loop that are inductively coupled together.

Some aspects relate to a resonant coil comprising at least one planar multiturn spiral current loop with at least one standalone capacitor, and at least one spiral current loop with at least one standalone capacitor, wherein the spiral current loop is galvanically connected to the planar multiturn spiral current loop.

Some aspects relate to a method of forming or using any of the devices described herein.

The resonant coil may further comprise a multilayer conductor with integrated capacitor structure inductively coupled to a plurality of inductively coupled current loops of the resonant coil.

The multilayer conductor with integrated capacitor structure may be disposed in a region of higher magnetic field than that of the plurality of inductively coupled current loops.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIGS. 1A-1D show an example of a resonant coil having two layers of thin, C-shaped conductors separated from one another by a dielectric layer and its equivalent circuit, according to some embodiments.

FIGS. 2A-2C show an example of the resonant coil disposed in a magnetic core, according to some embodiments.

FIG. 3 shows a resonant coil with 30° circumferential misalignment between the gaps in conductors of different layers, according to some embodiments.

FIG. 4 shows an image of a prototype according to the embodiment of FIGS. 2A-2D built using a standard PCB process, with a high-loss FR4 substrate as the dielectric layer, according to some embodiments.

FIGS. 5A and 5B show perspective and top-views respectively, of a resonant coil in which the conductors in respective layers each have two gaps with standalone capacitors, according to some embodiments. FIGS. 5C and 5D show schematic and cross-sectional views, respectively, of a resonant coil having a gap with a galvanic connection, according to some embodiments.

FIG. 6A shows a circuit diagram of a resonant coil with four ICCLs, according to some embodiments. FIGS. 6B and 6C, respectively show prototypes of the inductively coupled conductors with standalone capacitors, implemented with 4-layer PCBs for 2 cm and 6.6 cm outer diameters, according to some embodiments. FIG. 6D shows the layout of the prototypes of FIGS. 6B and 6C, according to some embodiments.

FIG. 7A shows labels for the four conductor layers of the structure of FIG. 7B. FIG. 7B shows an interleaving pattern for the connections between conductors and standalone capacitors, according to some embodiments.

FIG. 8 shows an ICCL layer in which one or more conductor traces may be added near the inner and outer radii of the conductor, according to some embodiments.

FIGS. 9A-9C show examples of toroidal conductors of ICCLs, according to some embodiments. FIG. 9D shows an example of barrel-wound conductors of ICCLs, according to some embodiments. FIG. 9E shows a side view illustrating one or more conductor traces being added near the top and bottom of the barrel-would structure of FIG. 9D.

FIGS. 10 and 11 show examples of multiturn windings for ICCLs according to some embodiments.

FIG. 12 shows that thicker conductors may be disposed in areas of lower magnetic field, according to some embodiments.

FIG. 13A shows an embodiment of a resonant coil in which a multilayer conductor with integrated capacitor structure may be placed on top of a plurality of ICCLs. FIG. 13B shows an exploded view of the multilayer conductor with integrated capacitor structure, according to some embodiments.

### DETAILED DESCRIPTION

The inventors have developed new resonant structures for handling high-frequency alternating current which include inductively coupled layers of thin (e.g., foil) conductors connected to standalone capacitors to form inductively coupled current loops (ICCLs).

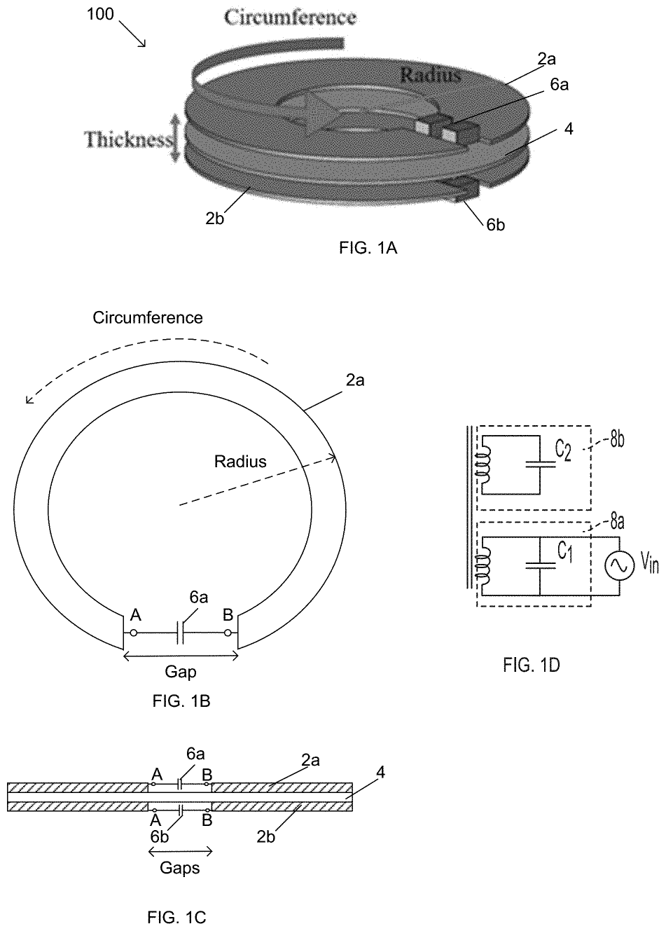

FIG. 1A shows an exploded perspective view of one example of a resonant coil 100 having two layers of thin, C-shaped conductors 2a, 2b separated from one another by a dielectric layer 4. The ends of each conductor 2a, 2b are galvanically connected to one or more standalone capacitors 6a, 6b. For example, standalone capacitor(s) 6a are connected in series across the two ends of conductor 2a and standalone capacitor(s) 6b are connected in series across the two ends of conductor 2b. The thickness, radius and circumference directions of the resonant coil 100 is labeled in FIG. 1A.

FIG. 1B shows a top view of the resonant coil 100 illustrating conductor 2a having its two ends, with terminals labeled A and B, connected to the respective terminals of standalone capacitor(s) 6a. That is, standalone capacitor(s) 6a are connected in series between terminals A and B. Standalone capacitor(s) 6a may be a single standalone capacitor or a plurality of standalone capacitors.

FIG. 1C shows a side view of the resonant coil 100 with illustrating that conductors 2a and 2b may be in contact with opposite sides of the dielectric layer 4. As shown in FIG. 1C, the bottom layer of the resonant coil may be substantially the same as the top layer, in some embodiments. That is, conductor 2b may have the same shape in top-view perspective as shown in FIG. 1B for conductor 2a. As with conductor 2a, conductor 2b has its two ends, with terminals labeled A and B, connected to the respective ends of standalone capacitor(s) 6b. That is, standalone capacitor(s) 6b are connected in series between terminals A and B of conductor 2b. Standalone capacitor(s) 6b may be a single standalone capacitor or a plurality of standalone capacitors.

The conductors 2a and 2b may be galvanically isolated from one another by the dielectric layer 4. However, in other embodiments, one or more conductors in different layers may be galvanically coupled to one another.

FIG. 1D shows a circuit diagram of the resonant coil 100. The resonant coil 100 may be excited by an AC voltage (Vᵢₙ). In this example, resonant coil 100 includes two inductively coupled current loops (ICCLs) 8a and 8b. ICCL 8a includes conductor 2a, represented by an inductance, and one or more standalone capacitors 6a, represented by capacitance C₁. ICCL 8b includes conductor 2b, represented by an inductance, and one or more standalone capacitors 6b, represented by capacitance C₂. ICCLs 8a and 8b are strongly inductively coupled to one another. This is at least partially due to the ICCLs 8a and 8b having significant (and in this case, complete) overlap with one another as viewed from a top-view perspective, and due to ICCLs 8a and 8b being close to one another in the thickness direction (in this case, only separated from one another by dielectric layer 4). In some embodiments, the conductors (e.g., 2a and 2b) may be separated by one another in the thickness direction by a distance of less than one-third the largest linear dimension of a conductor (e.g., 2a or 2b). In some embodiments, the magnetic coupling factor k between respective ICCLs may be relatively high (e.g., at least 0.1).

Having described the structure of resonant coil 100 and its circuit diagram, further aspects of the components of resonant coil 100 will be described.

As mentioned above, standalone capacitors, such as standalone capacitors 6a and 6b, are different from the integrated capacitance between respective layers of conductors 2. The standalone capacitors 6a and 6b are devices distinct from the conductors 2 or dielectric layer 4. By contrast, the multilayer conductors with integrated capacitors (as described in U.S. Pat. No. 10,109,413 and PCT application PCT/US2017/043377) are not standalone capacitors because their capacitance is formed between the conductors themselves, and not only have capacitive impedance, but also inductive impedance of approximately similar magnitude. The use of standalone capacitors may reduce the cost of the structure as compared to the multilayer conductors with integrated capacitors while still providing very low losses.

Standalone capacitors may be formed by any of a variety of devices. Standalone capacitors are devices with dominant capacitive (negative reactive) impedance at the desired frequency of operation; they may have inductive (positive reactive) impedance less than the capacitive impedance at the frequency of operation, and optionally less than 20% of the capacitive impedance at the frequency of operation. In some embodiments, the one or more standalone capacitors 6a, 6b are discrete capacitors. The standalone capacitor(s) may have individual packaging which can be galvanically connected to electrical conductors (e.g., by soldering). The standalone capacitor(s) may include, but are not limited to one or more of ceramic capacitors, film capacitors, mica capacitors, PTFE capacitors, tantalum capacitors, tantalum-polymer capacitors, thin film capacitors, electric double layer capacitors, polymer capacitors, electrolytic capacitors, niobium oxide capacitors, silicon capacitors, variable capacitors, and any combination, network or array of devices.

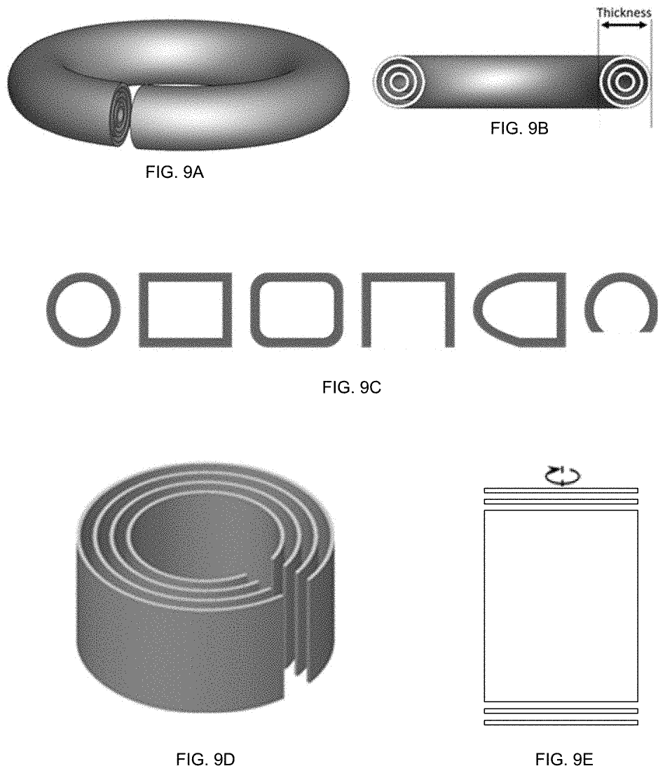

The capacitance of the standalone capacitors can be chosen for a desired magnitude of current to flow through each current loop, which mitigates the skin effect and the proximity effect, resulting in a high-performance (high-Q) electrical structure. The inductive coupling induces current in the different current loops. Such a structure allows for effective use of multiple electrical conductors with a total size (i.e., thickness) much larger than the size of the skin depth at the operating frequency. The total size refers to the sum of the thicknesses of the multiple electrical conductors in the direction perpendicular to the plane of current flow (i.e., the approximate plane in which a thin conductor is located). For example, the total size of planar foil conductors refers to the sum of the layer thicknesses of the foil conductors, and the total size of toroidal conductors refers to the sum of the radial thickness of the winding region as specified in FIG. 9B.

The conductors (e.g., 2a and 2b) may have a thickness of less than or equal to twice the skin depth of the conductive material at the operating frequency. In some embodiments, the operating frequency may be at or near the resonant frequency of the resonant coil, though in other embodiments the operating frequency and the resonant frequency may be quite different. As an example where the resonant frequency is close to the operating frequency, the resonant frequency may be 6.9 MHz and the operating frequency may be 6.78 MHz. Depending on the application, a resonant coil may be constructed such that the resonant frequency is in the range from 10 kHz to 1 GHz (inclusive). For example, the resonant frequency may be 10-100 kHz for automotive applications, 100-200 kHz for Qi standard, around 1-3 MHz for medical devices, or 6.78 MHz or 13.56 MHz or higher frequency bands for other applications, by way of example.

The conductors are electrical conductors which may be made of any electrically conductive material or combination of materials, including but not limited to one or more metals such as silver, copper, aluminum, gold and titanium, and non-metallic materials such as graphite. The electrically conductive material may have an electrical conductivity of higher than 200 kS/m, optionally higher than 1 MS/m. The electrical conductors may have any physical shape including, but not limited to, solid material, wire, magnet wire, stranded wire, litz wire, foil conductors, conductors laminated on a substrate, printed circuit board traces, integrated circuit traces, or any combination of them. Foil conductors are electrical conductors in which the size of the conductor orthogonal to the direction of current flow is much smaller (e.g., at least 10 times smaller) than the size of the conductor parallel to the direction of the current flow. Some examples for foil conductors may include, but are not limited to, foil layers forming a flat current loop (e.g., C-shaped, arc-shaped, rectangular-shaped, or any polygon-shaped conductors); foil layers wrapped around a cylinder or prism; barrel-wound and edge-wound conductors; and/or toroids or toroidal polyhedrons with a circular, polygonal or rounded-polygon cross-section which may have surfaces that are wholly or partially covered with one or more electrically conductive materials.

The dielectric layer 4 may be any electrically non-conductive material or combination of materials, including but not limited to one or more of air, FR4, PLA, ABS, polyimide, PTFE, polypropylene, Rogers Substrates, plastic, glass, alumina, or ceramic, for example. The dielectric material may have an electrical conductivity less than 100 kS/m, optionally less than 1 S/m.

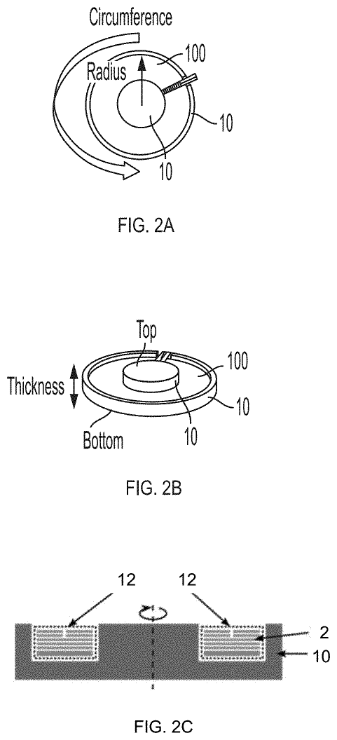

As illustrated in FIGS. 2A-2C, a resonant coil optionally may be placed in a magnetic core. FIGS. 2A and 2B show a top view image and a perspective view image, respectively, of resonant coil 100 within a magnetic core 10, which in this example is a pot core.

A magnetic core may be, wholly or partially, made of one or more ferromagnetic materials, which have a relative permeability of greater than 1, optionally greater than 10. The magnetic core materials may include, but are not limited to, one or more of iron, various steel alloys, cobalt, ferrites including manganese-zinc (MnZn) and/or nickel-zinc (NiZn) ferrites, nanogranular materials such as Co—Zr—O, and powdered core materials made of powders of ferromagnetic materials mixed with organic or inorganic binders. However, the techniques and devices described herein are not limited as to the particular material of the magnetic core. The shape of the magnetic core may be: a pot core, a sheet (I core), a sheet with a center post, a sheet with an outer rim, RM core, P core, PH core, PM core, PQ core, E core, EP core, or EQ core, by way of example. However, the techniques and devices described herein are not limited to the particular magnetic core shape.

As shown in FIG. 2C, which shows a cross-sectional diagram, a resonant coil may be disposed in a winding region. A winding region is a contiguous region, or volume, of space such that a cross-section can be defined, through which a significant portion (e.g., >75%) of the total current of the structure flows in one and only one direction (e.g., a circumferential direction). FIG. 2C shows an example of a resonant coil with multiple electrical conductors placed inside a winding region 12 of a magnetic pot core. In this case the winding region 12 is a toroid with rectangular cross-section surrounding the electrical conductors 2. The current loops in the winding region may be approximately concentric (or coaxial), where the centers, or the central axis, of the smallest circle that can encompass each current loop are located close to one another (i.e., a distance less than the average of the radius of the smallest circle that can encompass each of the current loops). Approximately concentric current loops may include current loops on the same plane (e.g., the top layer of electrical conductors in FIG. 2C) in which the larger current loops enclose the smaller current loops, or current loops on different plane whose centers are radially offset by less than the inner radius of the largest current loop. Current loops of any polygonal or other shape, comprising any type or shape of electrical conductor, may occupy a winding region.

Resonant coils such as those described herein can be implemented using various techniques. Some techniques include, but are not limited to, printed circuit board (PCB) processes, individually isolated conductors, foil conductors separated by dielectric layers, foil conductors laminated, coated, deposited, electroplated or sputtered on various dielectric materials and integrated circuit processes.

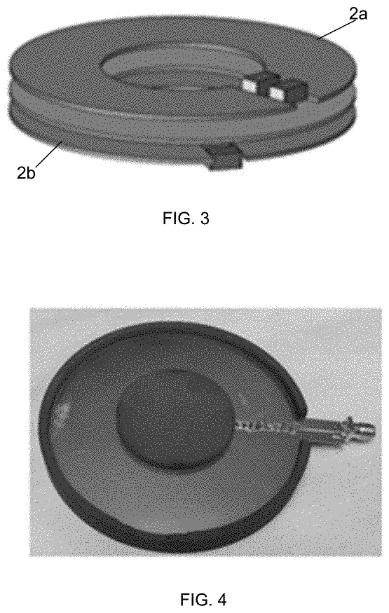

The inventors have recognized an arrangement of the conductors of the resonant coil that can reduce the excitation of the capacitance formed between the layers of ICCLs. As illustrated in FIGS. 1B and 1C, each conductor (e.g., conductors 2a and 2b) has a gap that extends from one end of the conductor to the other end. In the example of FIGS. 1B and 1C, the gaps in conductors 2a and 2b are aligned with one another in the circumferential direction. That is, they are stacked vertically directly above or below one another, as shown in FIG. 1C. By aligning the gaps of the conductors of the resonant coil the excitation of the intervening dielectric layer 4 may be reduced or avoid. The reason that alignment of the gaps reduces excitation of the intervening dielectric layer 4 is that due to the inductive coupling, the voltages of the conductors at each point along the circumference and radius of the resonant coil is substantially the same. Since substantially zero voltage difference appears between the conductors (e.g., between conductors 2a and 2b), the component of the electric field extending in the thickness direction of the dielectric layer 4 is substantially zero. Since the dielectric layer 4 is not excited by the voltage difference between the conductors in adjacent layers, the dielectric layer 4 does not need to be formed of a low-loss material. The openings of the different conductor layers do not have to be perfectly aligned to achieve a high-performance structure; approximate alignment can provide performance close to that achievable with exact alignment. Approximate alignment may be within an angle of less than 45% of the ratio of 180° divided by the number of gaps in each conductor layer (as discussed further below), or less than 30°. FIG. 3 shows a resonant coil 200 similar to resonant coil 100, but with 30° circumferential misalignment between the gaps in conductors 2a and 2b. Approximate alignment of the gaps allows a high-Q coil to be fabricated from a plurality of conductors with any non-conductive dielectric layer 4.

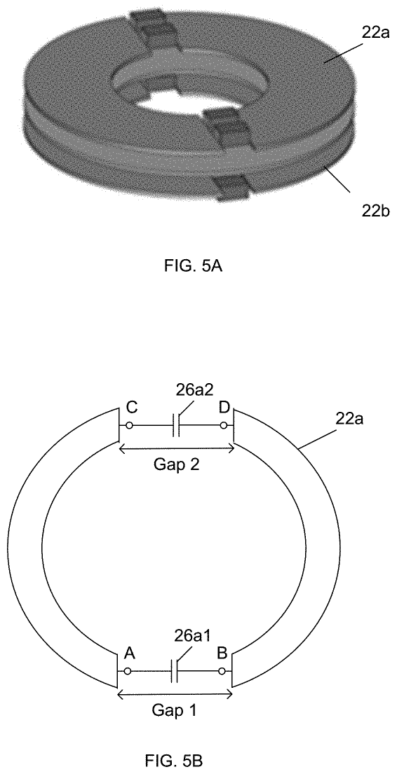

FIG. 4 shows an image of a prototype according to the embodiment of FIGS. 2A-2D built using a standard PCB process, with a high-loss FR4 substrate as the dielectric layer 4. The prototype exhibits a parallel resonance. Both of the standalone capacitors 6a and 6b have the same capacitance value. Despite the high-loss FR4 substrate material (with quality factor of 59) the prototype achieved a quality factor of 765 at 6.8 MHz, demonstrating five times better performance compared to typical coils fabricated on a PCB. In wireless power transfer applications, the higher quality factor of the coil can be used to achieve higher efficiency, higher power, longer range and/or smaller size.

The inventors have recognized that inductive current loops may have one or more gaps in the conductors. Multiple gaps in an inductively coupled current loop may reduce the required voltage rating of the standalone capacitors. Again, a layout may be used that reduces the excitation of the capacitance formed between the layers. Circumferentially aligning gaps in adjacent layers reduces or eliminates the excitation of the substrate layers. If multiple gaps are used in a conductor, then the excitation of the layer to layer capacitance can be reduced by attempting to align the gaps of each layer. If subsequent layers have an unequal number of gaps, or gaps in different circumferential positions, then aligning one or more gaps may reduce the excitation of the layer to layer capacitance.

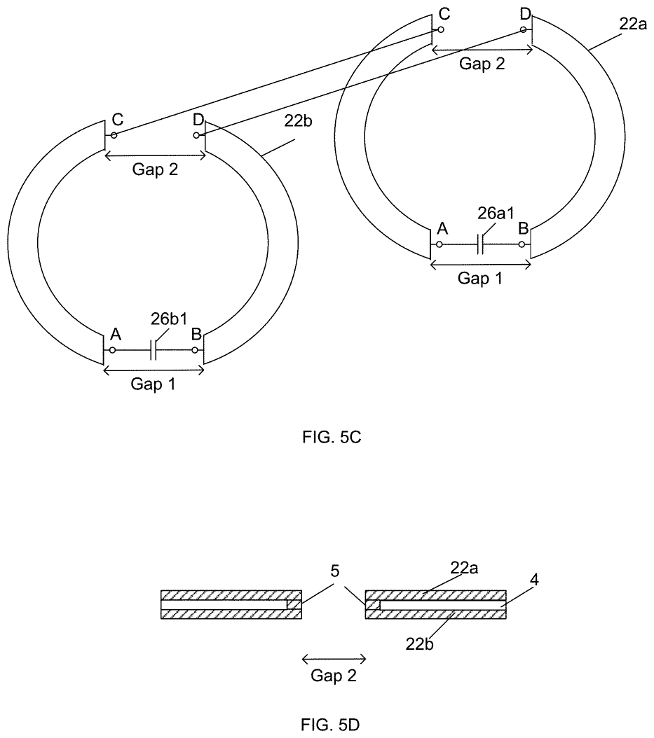

FIGS. 5A and 5B show perspective and top-views respectively, of a resonant coil in which the conductors each have two gaps. Such a structure is similar to resonant coil 100, but with conductors 22a and 22b each having two gaps, rather than one gap as in conductors 2a and 2b of resonant coil 100. One or more standalone capacitors is connected in series between the respective ends of the conductor that are separated by the gap. For example, as shown in FIG. 5B, conductor 22a has standalone capacitor(s) 26a1 connected in series across the end terminals A and B of the first gap (Gap 1), and has standalone capacitors 26a2 connected in series across the end terminals C and D of the second gap (Gap 2). The inductively coupled current loop including the second conductor 22b may be the same as the inductively coupled current loop including the first conductor 22b, and the two may be aligned, as shown in FIG. 5A. In this example, the gaps are arranged 180 degrees apart from one another around the circumference of the resonant structure. However, the gaps may be arranged in other locations with different angular displacements. A resonant coil may include any number of gaps, such as one gap, two gaps, three gaps, four gaps or more gaps, as the apparatus and techniques described herein are not limited in this respect.

The inventors recognize that some embodiments of ICCLs may have galvanic connections among the different current loops. Galvanically connected ICCLs, with galvanic connections at each end of the current loops, wherein each current loop comprises electrical conductors connected in series to one or more standalone capacitors, may provide similar benefits in mitigating the skin and proximity effects as galvanically isolated ICCLs. FIGS. 5C and 5D, show a schematic and cross-sectional view, respectively, of a resonant coil similar to that of FIGS. 5A and 5B, but instead of including standalone capacitors in series between terminals C and D the terminals of the respective conductors 22a and 22b are galvanically connected to one another. That is, terminal C of conductor 22a is galvanically connected to terminal C of conductor 22b, and terminal D of conductor 22a is galvanically connected to terminal D of conductor 22b. Such a connection may be formed by vias 5, as illustrated in FIG. 5D. The gap (Gap 2) with the galvanic connections need not be 180 degrees apart from Gap 1, as such a gap may be formed at any location, and any number of gaps with galvanic connections may be included. A resonant coil may include any number of galvanic connections between respective conductors 2.

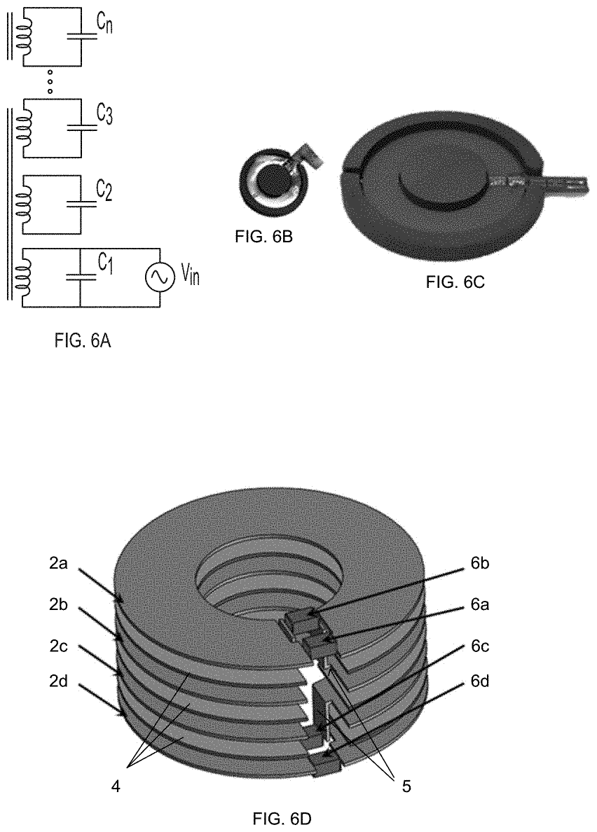

Returning to a general discussion of resonant coils with ICCLs, a resonant coil may have any number of ICCLs, and may have more than two ICCLs. For example, a resonant coil may have four ICCLs. A circuit diagram of a resonant coil with four ICCLs is shown in FIG. 6A. Prototypes of the inductively coupled conductors with standalone capacitors, implemented with 4-layer PCBs for 2 cm and 6.6 cm outer diameters, are shown in FIGS. 6B and 6C, respectively. The top side of the PCB includes connections to the top two layers of the PCB and the bottom side for the bottom two layers. The 2-cm structure has a quality factor of 336 at 13.56 MHz and the 6.6-cm structure has a quality factor of 732 at 6.78 MHz. Both of these structures outperform typical coils fabricated on a PCB of the same size by at least five times.

The layout of the PCB for the prototypes of FIGS. 6B and 6C is structured as shown in FIG. 6D. For PCBs the standalone capacitors may located on the top or bottom of the PCBs. For PCBs with more than two layers, vias may be formed to make connections from the inner layers to the top and/or the bottom of the PCB by vias, as shown in FIG. 6D. FIG. 6D shows a resonant coil with four conductors 2a-2d, four sets of one or more standalone capacitors 6a-6d, and three dielectric layers 4 between respective conductors. In FIG. 6D, the radially inner standalone capacitors 6b and 6c are disposed on the top and bottom of the resonant coil, respectively, and connected to the inner conductors 2b, 2c, respectively, through a corresponding via 5 without a galvanic connection to conductors 2a or 2d. The radially outer standalone capacitors 6a, 6d are connected to the outer conductors 2a, 2d, respectively without using vias. The standalone capacitors may be disposed at any radial location, though, as the techniques and apparatus described herein are not limited as to the location of the standalone capacitors or vias.

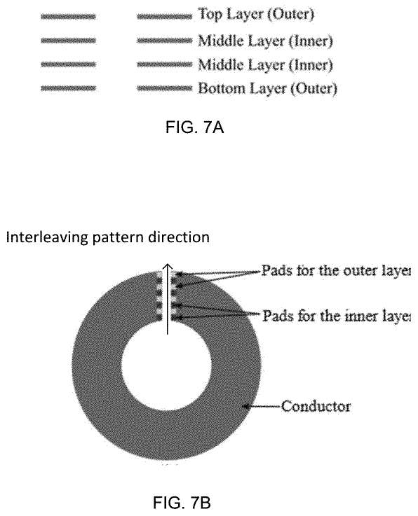

The inventors have recognized that interleaving connections between the conductors of the ICCLs and standalone capacitors can reduce loss and therefore achieve higher performance. Interleaving refers to an alternating pattern of connections as viewed from a top-view perspective, and is defined from the inside to the outside of the resonant coil. Interleaving is particularly useful for inductively coupled conductors in which a gap in one or more outer (e.g., top or bottom) electrical conductors is used as a space to provide electrical connection for one or more inner electrical conductors to connect to standalone capacitors. For example, in FIG. 6C, a 4-layer resonant coil is shown with four capacitors connected to each of the two solder pads on the top side of the PCB such that the radially outer four capacitors are connected to the top layer and the radially inner four capacitors are connected to the second layer, underneath the top layer. The solder pads for the bottom two layers are on the bottom side of the PCB. The performance of this structure using a 4-layer PCB can be improved if the four capacitors for each of the outer and the inner layers, as defined in FIG. 7A, are alternated, or interleaved, as shown in FIG. 7B, such that every other capacitor is alternately connected to the outer layer and the inner layer, respectively. The outer layer refers to those layers that are on the upper or lower surface of the PCB such that no vias are required to reach them. The inner layer may be reached by vias. For example, in a 2-layer PCB, the capacitors for the top layer can be connected to the top surface and those for the bottom layer to the bottom surface, and there are no inner layers. However, for a 4-layer PCB, the middle two layers use vias for connections out to the top and bottom surfaces, respectively. The interleaving can occur at different levels. For example, the four capacitors for each layer in the structure of FIG. 6C can be grouped into two groups of two capacitors each, which are then interleaved, such that the capacitors are connected to I-I-O-O-O-I-I-O-O layer going outward from the center, where “I” represents the inner layer and “0” represents the outer layer. Some other interleaving structures for 8 capacitors are: I-I-O-O-O-O-I-I, or I-O-I-O-I-O-I-O, or I-O-O-I-I-O-O-I. In general, for a total of N capacitors with M inductively coupled current loops, there are MN possible permutations of connections between different capacitors and layers. The inventors recognize that any of these permutations may be beneficial.

The inventors recognize that, for ICCLs with more than one gap, it may be beneficial to use different interleaving combinations in the same conductor. This may force better current distribution and reduce the loss of the coil. For example, consider a 4-layer planar coil similar to that of FIG. 6C but with two gaps in each conductive layer instead of one. In the same conductor, one gap may optionally have an interleaving pattern of I-I-O-O-I-I-O-O, and the other gap may have an interleaving pattern O-O-I-I-O-O-I-I. The inventors recognize that any combination of interleaving patterns for subsequent gaps may be beneficial. In other embodiments, the interleaving pattern may be the same for different gaps.

The structures shown in FIGS. 6D and 7B are for inductively coupled structures using a 4-layer PCBs where 2 layers are connected to one side of the PCB and the other 2 layers are connected to the opposite side. Depending on the application, some 4-layer structures may have all 4 layers connected to just one side of the PCB. For PCBs with larger layer counts, the number of layers connected to each side of the PCB may be more than two. This invention is not limited to 2- and 4-layer PCBs and applies to PCBs with more than 1 conductor, and is not limited to the particular side of the PCB each layer is connected to and/or the different possible interleaving structures among the capacitors of different layers. For example, an 8-layer PCB may have 4 layers connected to each side of the board, and the capacitors may be interleaved as 1-2-3-4-1-2-3-4, or 1-2-3-4-4-3-2-1, where the numbers 1-4 represents the different conductor layers.

ICCLs may be driven by connecting one or more of the ICCLs to an AC power supply. The inventors recognize that improved performance may be achieved if the connection leads between the current loops and the power supply are placed in the region of relatively low (e.g., lowest) magnetic field and/or if these current loops are connected to standalone capacitors. For example, in the structures with ICCLs without galvanic connections between layers placed in a magnetic pot core, the magnetic field intensity increases from the bottom (closed side) to the top (open side) of the pot core and/or from the radially outer to inner portion of the pot core. Thus, the lowest loss is incurred in the connection leads if they are placed at the bottom and closer to the outer radius of the pot core.

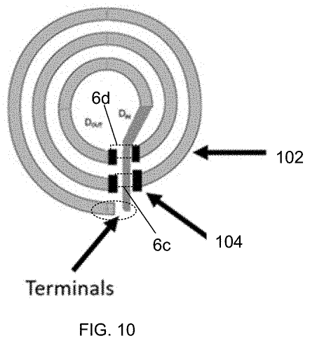

In some embodiments, the conductor of the resonant coil connected to the connection leads may be constructed with a plurality of turns. A plurality of turns can be used to change the impedance of the structure, which may make it easier to integrate into a power electronic circuit. Alternatively, or additionally, a plurality of turns may be used to achieve a voltage gain or reduction. Multiturn conductors are discussed further in connection with FIGS. 10 and 11,

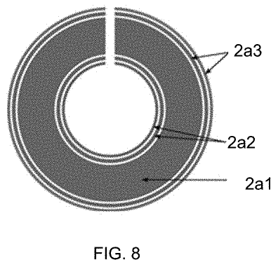

The ICCLs, for example, those implemented using PCB fabrication processes, may have edges in the electrical conductors parallel to the direction of current flow, around which the majority of the current flows due to induced eddy current in the electrical conductors. This phenomenon is termed lateral current crowding, in which current crowds laterally to the direction of the current flow, and induces extra AC power losses. In the resonant coils described herein, current may crowd at the inner and outer radial edges of the conductors 2. The inventors recognize that this phenomenon of lateral current crowding can be mitigated by adding one or more additional current loops of reduced width close to the edges of the main electrical conductor. These additional current loops may or may not be galvanically connected to the main electrical conductor. The current loops may comprise electrical conductors with thickness perpendicular to the direction of current flow up to five times the skin depth at the operating frequency, and may themselves be connected to standalone capacitors, which can be chosen to select the desired current to flow through them. For example, as shown in the example ICCL in FIG. 8, which may be formed using a PCB process, one or more conductor traces may be added near the inner and outer radii of the conductor. As shown in FIG. 8, a main conductor 2a1 has one or more inner conductors 2a2 and/or outer conductors 2a3 of the same shape and smaller width (in the radial direction) than the main conductor 2a1 adjacent to the main conductor 2a1. Adding such additional traces, or current loops, can improve the performance or reduce the power loss of the structure. Finite element simulations show that the improvement (reduction in power losses) may be up to 15% or more per additional trace or current loop added. The inventors recognize that such additional conductors, or current loops, may be beneficial in implementation of ICCLs using other foil conductors; current loops with physically smaller electrical conductor sizes may be added near the edges of another current loop with larger conductor size. An analogous structure may be formed for the barrel-wound structure of FIG. 9D, discussed below, by forming vertically separated sections at the top and bottom of the cylinder, as shown in FIG. 9E, which shows a side-view of such a structure from a view not including the gaps of FIG. 9D. The current loops described in this paragraph reduce lateral current crowding which may be useful for a variety of applications. They can enable a mass and volume reduction by reducing the magnetic core material without a significant degradation in performance. Furthermore, they can enable thin, high-performance coils for height-constrained applications.

The structures and techniques described herein, with example ICCL implementations on conductor layers and/or PCBs, can be applied to any other type of electrical conductors or combination of electrical conductors. Some embodiments include implementation of ICCLs using foil conductors. One example of such an ICCL implementation using foil conductor is a nested toroid with a circular cross-section as shown in FIGS. 9A and 9B, which shows three toroids with different circular cross-section nested within one another. The toroids may be galvanically isolated from each other via a suitable dielectric material, including air, for example. In other embodiments they the conductors may be galvanically connected to one another. Some other examples include toroids or toroidal polyhedrons with various cross-sections, including a circle or portion of a circle, rectangle, rectangle with rounded corners, rectangle with one or more sides removed, combination of straight lines and curves among other; some of which are shown in FIG. 9C, which illustrates cross-sections having the following shapes, in order from left to right: circle, rectangle, rectangle with rounded corners, rectangle with one side removed, combination of straight lines and curves, and portion of a circle. In some embodiments, ICCLs are made from wrapping foil layers around a cylinder or prism, as illustrated in FIG. 9D. FIG. 9D shows an example ICCL using barrel-wound foil conductors wrapped around a cylinder, showing gap in each conductor for connecting to one or more standalone capacitors. In general, the techniques and structures described herein apply to ICCLs with any type of electrical conductors, or foil conductors.

ICCLs are not limited to current loops with a single turn, and may be implemented with multiturn current loops. For example, the ICCL may be modified such that each layer is a multiturn spiral connected to one or more standalone capacitors. Multiturn current loops may be inductively coupled and may be placed in a winding region, optionally inside a magnetic core. There may be multiple current loops, each with multiple turns in each conductor layer. The multiple turns of a current loop may be implemented in different PCB layers using vias. Such a multiturn implementation of ICCLs is not limited to a PCB, however. For example, a multiturn ICCL using a barrel-wound foil conductor (similar to FIG. 9D) or toroidal foil conductor (similar to FIG. 9A) may be implemented by wrapping the group of conductors in a spiral and/or helical manner.

The inventors recognize that it may be advantageous to construct a planar spiral current loop using only one layer. This may be particularly useful for coils constructed on a PCB. As shown in FIG. 10, a spiral may be constructed in or on a single layer of a PCB by having the conductor 102 spiral inwards towards the middle. Each loop may have a break where a bridge component 6c, 6d can be connected in series with conductor 102. Pads 104 at the breaks in conductor 102 allow for attachment (e.g., soldering) of the bridge component(s) 6c, 6d. A bridge component may be a standalone capacitor to provide at least a portion of the resonant capacitance. The bridge component may be a low-impedance electrical component (e.g., a resistor with a resistance less than half the resistance of the total conductor path, and/or a conductive bridge). The conductor in the middle of the spiral then exits the spiral underneath each bridge component and/or between the attachment points for the bridge component. This planar spiral current loop may be used as a single resonant coil optionally placed near a magnetic core. Alternatively, a plurality of planar multiturn spiral current loops can be inductively coupled together to form an ICCL. This structure may reduce parasitic capacitance enabling low loss; allow a spiral coil to be constructed using a single layer; and reduce the required voltage rating of the capacitors.

Some embodiments of multiturn ICCLs, with or without galvanic connections, may be implemented with a plurality of multiturn spiral windings, a plurality of planar multiturn spiral current loops (an example of which is shown in FIG. 10) or a plurality of some combination of multiturn spiral windings and planar multiturn spiral windings inductively coupled together. The inventors recognize that not all layers need to have a return path that breaks the spiral; in other words, not all layers need to be planar multiturn spiral current loops (an example of which is shown in FIG. 10). FIG. 11 shows an example of a 4-layer PCB that has four approximately concentric layers A, B, C, and D labeled in the respective order from bottom to top. Layers A and D may be constructed using a planar multiturn spiral current loop. Layer B may be a multiturn spiral winding where the conductor in the inner radius has a via to the return path of Layer A. Layer C may be a spiral winding where the conductor in the inner radius has a via to the return path of Layer D. Optionally, any combination of vias connecting Layers B and/or C to Layers A and/or D can provide the return path for the current to exit the inner portion of the spiral. Each layer may have one or more standalone capacitors. The result of this example is a 4-layer series resonant structure that can be constructed using a 4-layer PCB. Analysis suggests such a structure may have as little as a quarter of the loss of a single layer structure.

The inventors recognize that it may be beneficial for the conductors of a multiturn ICCL to start and end at approximately the same circumferential position. Although perfect alignment may have the best performance, and loss reduction is possible with circumferential position offsets between the respective ends of the conductors in different layers. In some embodiments, the circumferential offset may be less than 60 degrees.

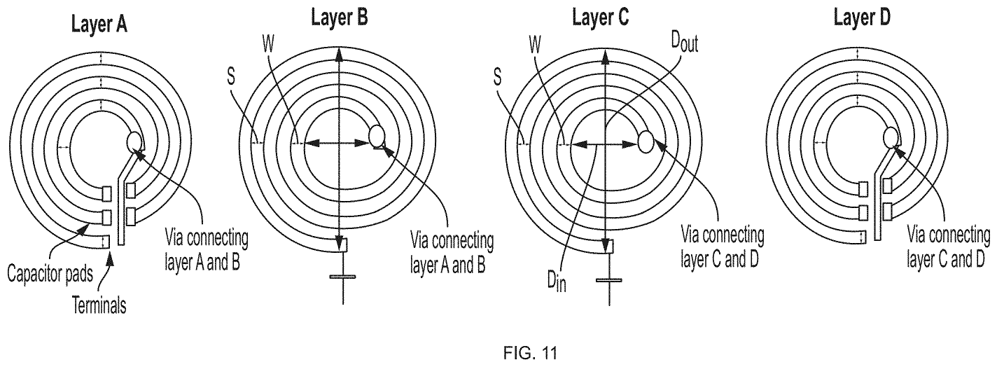

In some embodiments, electrical conductors of different current loops of the ICCL may have different thicknesses. The thickness of a conductor is defined in the vertical direction of FIGS. 1A and 1C and the radial direction of FIG. 9B, for example. The inventors have recognized and appreciated the thickness of each electrical conductor may be chosen to improve the performance (e.g., loss) of the ICCL. Each electrical conductor in an ICCL incurs two types of loss, one due to the electrical resistance of the conductor and the other due to proximity effect from nearby electrical conductors which induces eddy current. The former is inversely proportional to the thickness of the conductor and the latter is directly proportional to the thickness of the conductor cubed, and the magnetic field intensity squared. Thus, there exists an optimum conductor thickness at different locations inside the winding region depending on the local magnetic field intensity; the optimum conductor size is largest at the region of lowest magnetic field intensity and smallest at the region of highest magnetic field intensity. An example is shown in FIG. 12, wherein the magnetic field increases from the bottom to the top. FIG. 12 shows an example of a resonant coil in which four conductor layers are included, and have decreasing thickness from the bottom conductor to the top conductor. In some embodiments, the thickness of the thickest layer may be up to five times the skin depth at the operating frequency. In practice, the commercially available conductor size may be chosen that is approximately closest to the optimal conductor size required. Such optimum, or approximately close to the optimum, selection of conductor size based on the local magnetic field intensity can improve the performance of ICCL by up to 20%.

The inventors recognize that the ICCL performance can be further improved by choosing the capacitance of the standalone capacitors to achieve the optimum current distribution among different current loops. In ICCLs with electrical conductors of the same thickness, the standalone capacitors may be chosen such that the capacitance is higher for current loops in the region of higher magnetic field and lower for those in the region of higher magnetic field. Such a selection reduces the current in the current loop in the region of lower magnetic field, which in turn reduces the magnetic field at other region of space, thereby reducing the AC power losses due to the proximity effect. For ICCLs with electrical conductors of different thicknesses, selected as aforementioned, the standalone capacitors may be chosen to have higher capacitance for thicker electrical conductors and lower for thinner electrical conductors in order to reduce losses in the smaller electrical conductors. These strategies for selecting the capacitance of the standalone capacitors can improve the ICCL performance by up to 20% or more. Additionally, for ICCLs with thick electrical conductors, the standalone capacitors may be chosen to be higher for the conductors in the highest field and lower for conductors in lowest field in order to reduce proximity effect. These strategies for selecting the standalone capacitors can improve the ICCL performance by up to 20% or more.

Some embodiments include the combination of ICCLs with standalone capacitors with the multilayer conductors with integrated capacitors (as described in U.S. Pat. No. 10,109,413 and PCT application PCT/US2017/043377). One such implementation is a structure with ICCLs made of larger electrical conductor size in the region of low magnetic field, combined with the multilayer conductors with integrated capacitors made of smaller electrical conductor size in the region of high magnetic field. Such a combination may have advantages such as achieving a high total capacitance, achieving a large total cross-section of electrical conductors in a fixed winding area, and increasing the range of available electrical conductor size among others, which improves the performance of the ICCL. In some embodiments, the multilayer conductors may each have a single gap or a plurality of gaps.

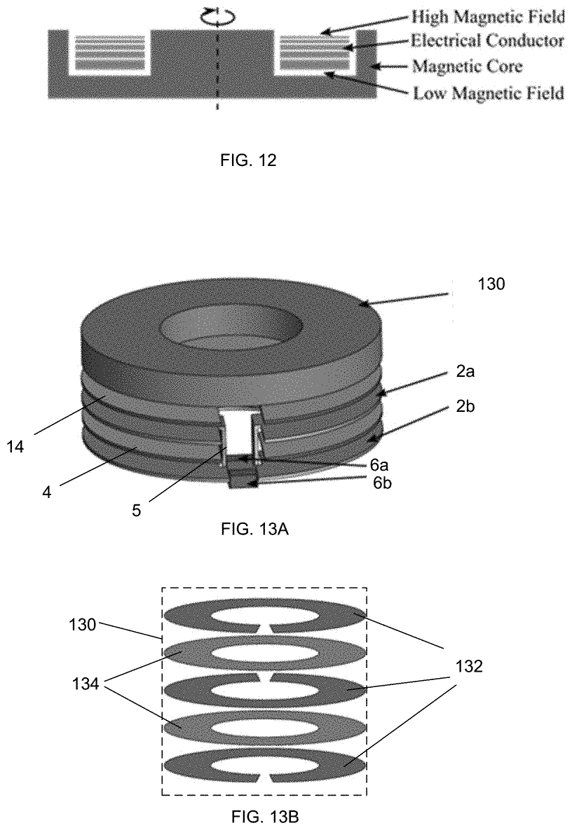

FIG. 13A shows an embodiment of a resonant coil in which a multilayer conductor with integrated capacitor structure 130 (without standalone capacitors) may be placed on top of a plurality of ICCLs (e.g., with conductors 2a, 2b separated by a dielectric layer 4) each connected to one or more standalone capacitors (e.g., 6a, 6b). This combination may be placed in a magnetic core, such as a magnetic pot core, with the multilayer conductor with integrated capacitors on top of the two ICCLs. In practice, the ICCLs, which are in a region of higher magnetic field, may be made of thicker conductor layers, and the multilayer conductor with integrated capacitors may comprise thinner conductor layers. The multilayer conductor with integrated capacitor structure may be galvanically isolated from the ICCLs by a dielectric layer 14, which may be formed of a low-loss material. If the bottom conductor layer of the integrated capacitor structure 130 has a gap aligned with the top conductor layer of the plurality of ICCLs the dielectric layer 14 may be formed of a high-loss material. The multilayer conductor with integrated capacitor structure 130 may be inductively and/or capacitively coupled to the plurality of ICCLs. In this example, a via 5 may connect the conductor 2a to the standalone capacitor(s) 6a on the bottom of the structure.

FIG. 13B shows an exploded view of one example of a multilayer conductor with integrated capacitor structure 130 having alternating conductors 132 (e.g., which may be thin, foil conductors) separated by respective dielectric layers 134. In some embodiments, the conductors 132 may have gaps at locations that alternate 180 degrees apart (e.g., front, back, front, etc.) in respective conductor layers. However, different types and or number of gaps may be included, and any number of layers may be included. In some embodiments, dielectric layers 134 may be formed of a low-loss material as they serve as the dielectric material of integrated capacitors between respective conductors 132.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A resonant coil, comprising:
a plurality of conductors forming a plurality of inductively coupled current loops, the plurality of conductors comprising;
a first conductor having a first end and a second end, the first end and the second end being separated by a first gap; and
a second conductor having a third end and a fourth end, the third end and the fourth end being separated by a second gap; and
at least one standalone capacitor comprising at least one first capacitor connected to the first end and the second end of the first conductor.

2. The resonant coil of claim 1, wherein the first gap is approximately aligned with the second gap.

3. The resonant coil of claim 1, wherein the first conductor and the second conductor are in respective layers of a printed circuit board.

4. The resonant coil of claim 1, wherein the at least one standalone capacitor provides a resonant capacitance for the resonant coil.

5. The resonant coil of claim 4, wherein a capacitance between the first conductor and the second conductor substantially does not contribute to the resonant capacitance.

6. The resonant coil of claim 1, wherein the at least one standalone capacitor further comprises at least one second standalone capacitor connected to the third end and the fourth end of the second conductor.

7. The resonant coil of claim 1, wherein the first and second conductors are galvanically isolated from one another.

8. The resonant coil of claim 1, wherein the first and second conductors are galvanically connected to one another, wherein a galvanic connection is formed by making a break in the first and second conductors and connecting the respective ends of the break of the first and second conductors.

9. The resonant coil of claim 1, wherein some of the plurality of conductors are galvanically isolated from one another, and some of the plurality of conductors are galvanically connected to one another, wherein a galvanic connection is formed by making a break in the first and second conductors and connecting the respective ends of the break of the first and second conductors.

10. The resonant coil of claim 1, wherein the first and second conductors each have a C-shape.

11. The resonant coil of claim 1, wherein the first and second conductors are planar.

12. The resonant coil of claim 1, wherein the first and second conductors each have a toroidal C-shape with an open cross-section or a closed cross section.

13. The resonant coil of claim 12, wherein the first conductor is nested within the second conductor.

14. The resonant coil of claim 1, wherein the at least one standalone capacitor comprises a plurality of standalone capacitors with interleaved connections to at least the first and second conductors.

15. The resonant coil of claim 1, further comprising a third conductor outside an edge of the first conductor, the first conductor having a smaller width than that of the first conductor.

16. The resonant coil of claim 1, wherein the first and second conductors have different thicknesses.

17. The resonant coil of claim 1, wherein the first and second conductors are approximately concentric.

18.-30. (canceled)

31. The resonant coil of claim 1 in combination with a high-permeability magnetic material to shape a magnetic field.

32. (canceled)

33. (canceled)

34. The resonant coil of claim 1, wherein the at least one standalone capacitor comprises a plurality of standalone capacitors of approximately equal capacitance.

35. The resonant coil of claim 1, wherein the at least one standalone capacitor comprises a plurality of standalone capacitors with increasing capacitance for increasing thickness of a conductor to which a standalone capacitor is connected.

36. The resonant coil of claim 35, wherein the capacitance increases approximately proportionally to an increase in thickness of the conductor.

37. The resonant coil of claim 1, wherein the at least one standalone capacitor comprises a plurality of standalone capacitors with capacitance increasing with a strength of a magnetic field in which individual standalone capacitors are disposed.

38.-41. (canceled)

42. The resonant coil of claim 1, further comprising a multilayer conductor with integrated capacitor structure inductively coupled to a plurality of inductively coupled current loops of the resonant coil.

43. The resonant coil of claim 42, wherein the multilayer conductor with integrated capacitor structure is disposed in a region of higher magnetic field than that of the plurality of inductively coupled current loops.

44. The resonant coil of claim 1, wherein the first conductor has a plurality of turns.

45. The resonant coil of claim 1, wherein a magnetic coupling coefficient between adjacent galvanically isolated current loops of the plurality of inductively coupled current loops exceeds k=0.1 and/or a distance between the adjacent galvanically isolated current loops is less than ⅓rd an average diameter of the plurality of inductively coupled current loops.

46. The resonant coil of claim 45, wherein the magnetic coupling coefficient exceeds k=0.8 and/or a distance between the adjacent galvanically isolated current loops is less than 1/10th the average diameter.

47. The resonant coil of claim 46, wherein the magnetic coupling coefficient exceeds k=0.9 and/or a distance between the adjacent galvanically isolated current loops is less than 1/15th the average diameter.
